(19) United States
(12) Patent Application Publication
(10) Pub. No.: US 2002/0100387 A1
(43) Pub. Date: Aug. 1, 2002

(54) Method of decorating a plastic part and associated business model

(76) Inventor: RIchard N. Churchwell, Gilbert, AZ (US)

Correspondence Address: TREXLER, BUSHNELL, GIANGIORGI,, BLACKSTONE & MARR, LTD., 36TH FLOOR, 105 WEST ADAMS STREET, CHICAGO, IL, 60603, US

(21) Appl. No.: 10/057,411

(22) Filed: Jan. 23, 2002

Related U.S. Application Data
(60) Provisional application No. 60/265,196, filed on Jan. 31, 2001.

(51) Int. Cl. B41L 35/14

(52) U.S. Cl. 101/488

(57) ABSTRACT

Methods of decorating a plastic part by either using sublimation dye(s) and thermal transfer of a printed image, or by using an antistatic treated plastic film. Either one of the methods provides that a business model is possible. The business model is directed at allowing a customer to design a “one-of-a-kind” graphic, and order a plastic part decorated with the “one-of-a-kind” graphic. Specifically, a web site may be provided which provides that the customer can design (and order) a “one-of-a-kind” plastic cell phone cover.

### BACKGROUND

The present invention relates generally to methods of decorating plastic parts, and relates more specifically to a method of decorating a plastic part which makes it economically possible to decorate a plastic part with a high resolution, “one of a kind” graphic within a high volume production environment. The present invention also relates to business models for selling “one-of-a kind” decorated plastic parts.

Another aspect of the present invention relates to using antistatic treated films to enable direct digital color laser printing to film with standard toners.

James R. Koelsch, “Paint Parts in One Shot”, Molding Systems, October 1998, pp. 30-35, discloses one prior art process of decorating a plastic part with a graphical image. The process which is disclosed in Koelsch is often referred to as “in-mold decorating” (IMD), and is illustrated step-by-step generally in block diagram form in FIG. 1. As shown in FIG. 1, the process provides that a graphic is initially silk screen printed onto a plastic film (box 10). Then, the film is vacuum formed or hydro-formed to shape the film in accordance with the part design (box 12). The shaped film is then die-cut (box 14) and transferred to a molding operation (box 16) where it is positioned and held in the mold cavity of a plastic injection molding machine (box 18). The mold cavity is then closed, and the part is injection molded (box 20). When resin is injected into the mold cavity, the resin and film bond together to form an integral, plastic piece. The finished part is then ejected from the mold cavity (box 22).

The silk screen printing process (corresponding to box 10 in FIG. 1) is well known in the art, and is generally relatively involved and expensive. The process requires that the four basic colors—black, cyan, magenta and yellow—which form the image, be separated onto four different screens. The screens are then used to print the resulting, multicolor image onto the plastic film.

Due to the expense of utilizing the silk screen printing process (and having to separate the image onto four different screens), the process does not lend itself well to low volume productions, and is generally limited to medium to high volume production runs. Additionally, while sometimes quick-cure ultraviolet (UV) inks are used in silk screen printing processes, usually solvent-based inks (such as Proll or Noriphan® HTR) are used. Such inks, after they are deposited onto plastic film, take a long time (such as 1-5 hours) to cure. Additionally, such inks (i.e. solvent-based inks) invoke environmental concerns. Still further, the inks which are typically used in the silk screen printing process are subject to distortion or burning while in the mold cavity. As such, it is necessary to use inks which are durable and, at times, to use specific gating methods to avoid damaging the image which has been printed onto the film. Such a gating method is disclosed, for example, in U.S. Pat. No. 6,090,327. Still another disadvantage of using the silk screen printing process is that the process generally cannot be used to produce high resolution images, such as photographic quality images.

Another prior art process which is used to decorate plastic parts is often referred to as “aqua-graphics”. The process provides that water-soluble ink is silk screen printed onto a water soluble film. While the process is somewhat different than the process which has been described above, the process still involves silk screen printing. Hence, the process is generally limited to medium to high volume production runs, and high resolution graphics cannot be produced.

Yet another prior art process which is used to decorate plastic parts is a modified in-mold decorating (IMD) process whereby an image is silk screen printed onto a plastic film, the plastic film is inserted into a mold cavity and a plastic part is injection molded. The mold cavity is then opened, and the plastic part is removed from the film (i.e. the film peels away from the plastic part). The process provides that the image which had been printed onto the film is thermally transferred to the surface of the plastic part, with a “ghost image” remaining on the film. Alternatively, the plastic film can be heated and pressed onto the plastic part outside of the mold to thermally transfer the image from the film to the plastic part. Regardless of whether the transfer of the image occurs inside or outside the mold cavity, the process still involves silk screen printing. Hence, the process is generally limited to medium to high volume production runs, and high resolution graphics cannot be produced.

Because prior art processes do not economically lend themselves well to low production runs, business models have not been directed at allowing a customer to design a “one-of-a-kind” graphic, and order a plastic part decorated with the “one-of-a-kind” graphic. For example, web sites have not generally been configured to allow a customer to design his or her own cell phone cover (i.e. a “one-of-a-kind” custom cell phone cover design), and then order the cell phone cover which has been designed.

### OBJECTS AND SUMMARY

An object of an embodiment of the present invention is to provide a method of decorating plastic which makes it economically possible to decorate plastic with high resolution, “one of a kind” graphics within a high volume production environment.

Another object of an embodiment of the present invention is to provide a business model directed at allowing a customer to design a “one-of-a-kind” graphic, and order a plastic part decorated with the “one-of-a-kind” graphic.

Still another object of an embodiment of the present invention is to provide a method of using antistatic treated films to enable direct digital color laser printing to film with standard toners.

Briefly, and in accordance with at least one of the foregoing objects, an embodiment of the present invention provides a method of decorating a plastic part. The method includes steps of printing an image onto a transfer medium, such as printing onto a high quality paper using sublimation dye(s), placing the transfer medium against a film, applying pressure and heat to at least one of the transfer medium and film such that at least a portion of the image which has been printed onto the transfer medium transfers onto the film, possibly shaping and cutting the film, positioning the film inside a mold cavity of an injection molding machine, closing the mold cavity, injecting a resin into the mold cavity, ejecting the plastic part from the mold cavity, where the plastic part includes plastic and the film with the image thereon bonded to the plastic.

Another embodiment of the present invention provides a method of decorating a plastic part, where the method includes steps of laser printing onto at least one side of an antistatic treated film, possibly applying a protective coating item or laminate item to the antistatic treated film, possibly shaping and cutting the film, possibly curing the ink on the film, positioning the film inside a mold cavity of an injection molding machine, closing the mold cavity, injecting a resin into the mold cavity, ejecting the plastic part from the mold cavity, where the plastic part includes plastic and the film with the image thereon bonded to the plastic.

Another aspect of the present invention provides a business model directed at allowing a customer to design a “one-of-a-kind” graphic, and order a plastic part decorated with the “one-of-a-kind” graphic. Specifically, a web site may be provided which allows a customer to enter the web site, design a “one-of-a-kind” graphic, and order a plastic part decorated with the “one-of-a-kind” graphic. For example, the web site may provide that the customer can design (and order) a “one-of-a-kind” plastic cell phone cover.

### BRIEF DESCRIPTIONS OF THE DRAWINGS

The organization and manner of the structure and function of the invention, together with further objects and advantages thereof, may be understood by reference to the following description taken in connection with the accompanying drawings, wherein:

FIG. 1 is a block diagram of a prior art in-mold decorating (IMD) process for decorating a plastic part;

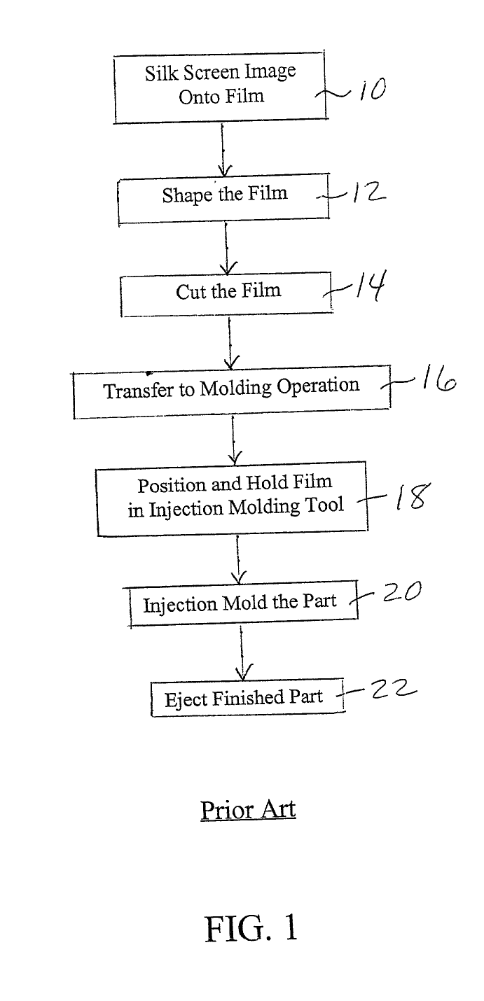

FIG. 2 is a schematic diagram showing the steps of a method of decorating a plastic part, where the method is in accordance with an embodiment of the present invention;

FIG. 3 is a block diagram corresponding to the method illustrated in FIG. 2;

FIG. 4 is a schematic diagram showing the steps of a method of decorating a plastic part, where the method is in accordance with another embodiment of the present invention;

FIG. 5 is a block diagram corresponding to the method illustrated in FIG. 4; and

FIG. 6 is a block diagram illustrating a business model which is in accordance with an embodiment of the present invention.

### DESCRIPTION

While the present invention may be susceptible to embodiment in different forms, there are shown in the drawings, and herein will be described in detail, embodiments of the invention with the understanding that the present description is to be considered an exemplification of the principles of the invention and is not intended to limit the invention to that as illustrated and described herein.

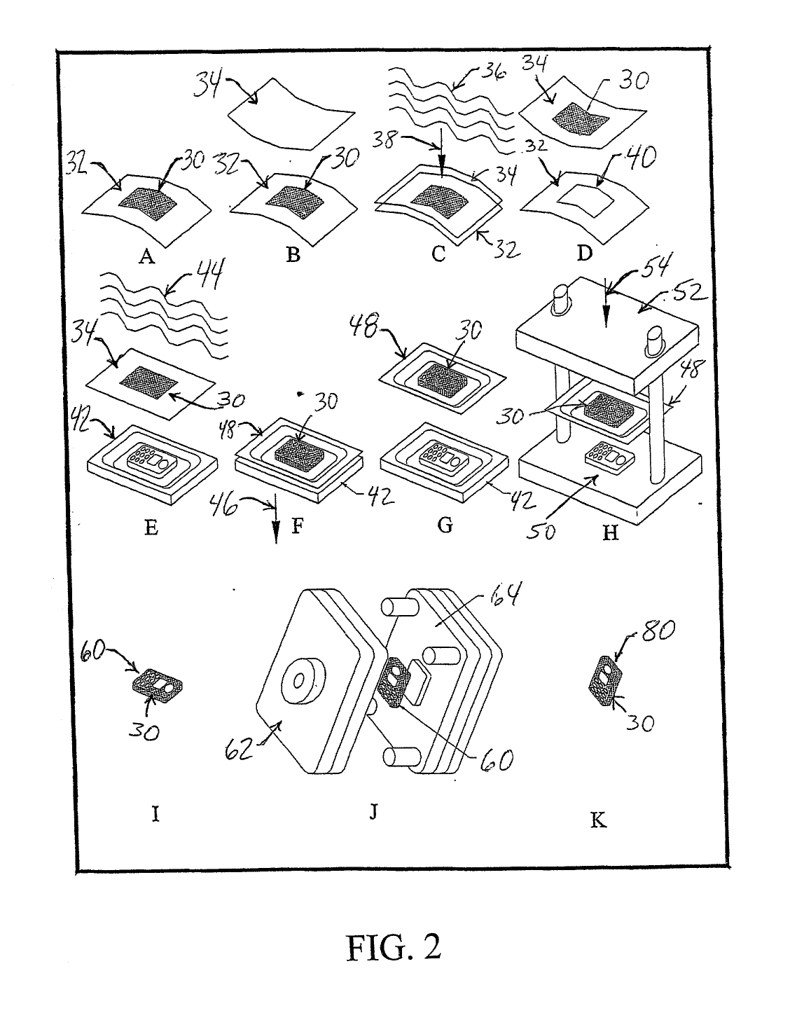

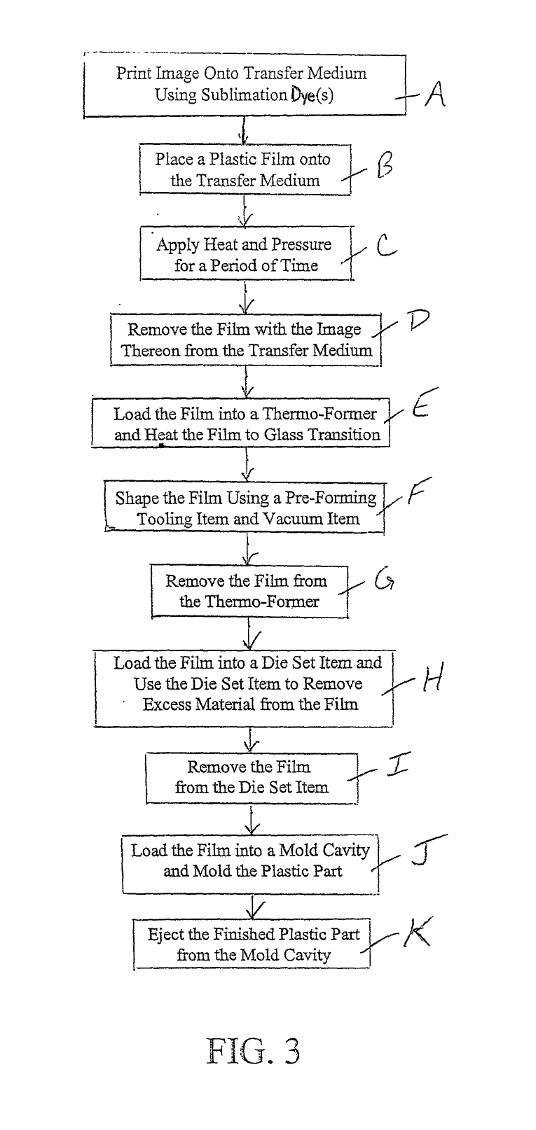

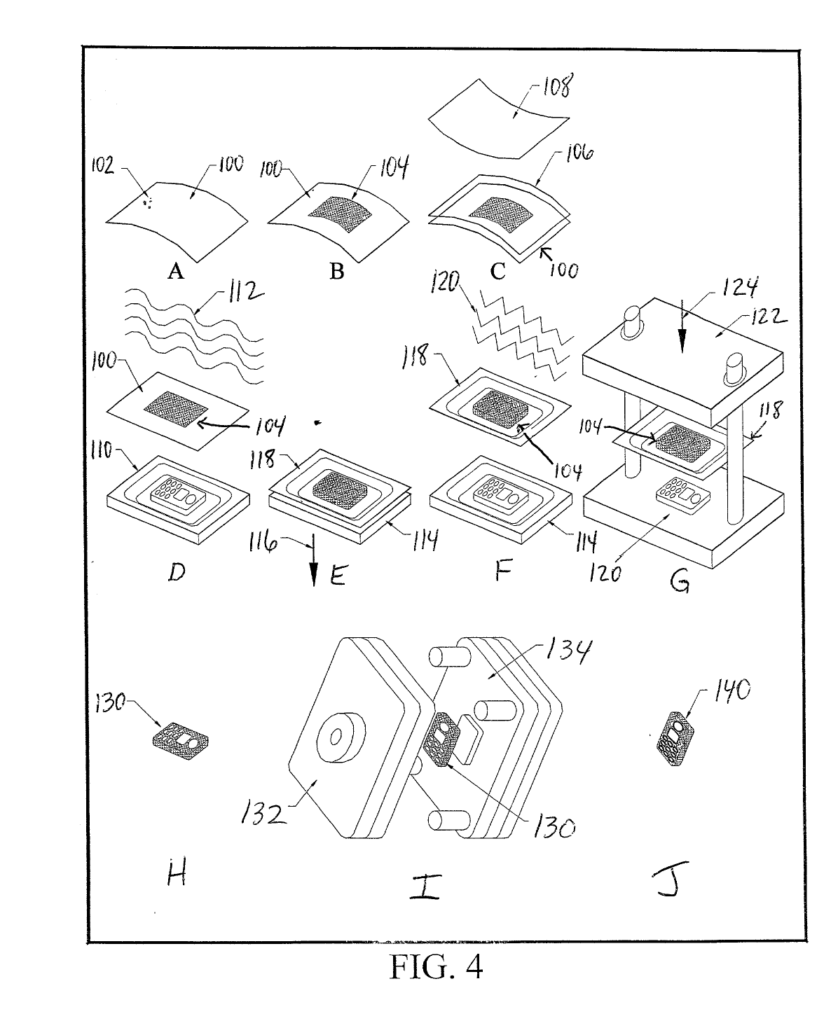

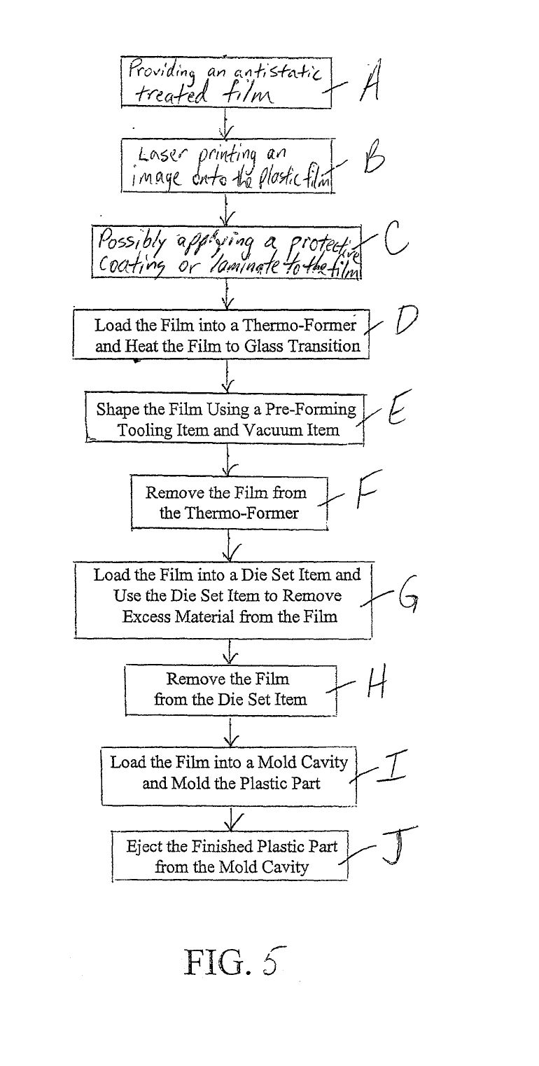

FIG. 2 is a schematic diagram showing the steps (illustrated as steps “A” thorough “K” in FIG. 2) of a method of decorating a plastic part, where the method is in accordance with an embodiment of the present invention. FIG. 3 is a block diagram which corresponds to the method illustrated in FIG. 2. Likewise, FIG. 4 is a schematic diagram showing the steps (illustrated as steps “A” thorough “J” in FIG. 4) of a method of decorating a plastic part, where the method is in accordance with another embodiment of the present invention. FIG. 5 is a block diagram which corresponds to the method illustrated in FIG. 4. Each of the methods makes it economically possible to decorate plastic with high resolution, “one of a kind” graphics within a high volume production environment. In other words, the method makes it economically feasible to produce even a single plastic part which is decorated with a high resolution, “one of a kind” graphic.

The method illustrated in FIGS. 2 and 3 provides that initially an image 30 is printed onto a transfer medium 32 (step “A” in FIGS. 2 and 3). Specifically, the transfer medium 32 may be a high quality ink jet paper, and the dye (or dyes) which is used to print the image may be sublimation dye (or dyes). The image 30 may be a digital image initially stored in the memory of a computer, and may be printed onto the paper using an ink jet printer utilizing inkjet cartridges that contain sublimation dye. Specifically, the ink jet printer may be an Epson Stylus Color 3000 ink jet printer, which is configured to use separate ink cartridges for the four main colors—cyan, magenta, yellow and black—and which can print photograph quality images. Alternatively, a color laser printer utilizing sublimation toner dyes can be used.

Regardless of which type of printer is used, preferably the printer is capable of dispensing sublimation dyes, and sublimation dyes are used to print image 30. Sublimation involves the process of a solid substance changing directly to a gas or vapor, without first passing through the intermediary liquid state. Sublimation dyes are dyes which are heat-activated and change into a gas when heated and have the ability to bond with certain surfaces. Sublimated images are generally extremely scratch resistant and durable because the image is actually embedded in, and therefore protected by, the material on which the image is printed. Sublimation dye print cartridges are generally presently commercially available.

After the image 30 is printed onto the transfer medium 32, a plastic film 34 or other material is placed on the transfer medium 32 (step “B” in FIGS. 2 and 3), and heat (using heat item 36) and pressure (using pressure item 38) are applied thereto for a period of time (step “C” in FIGS. 2 and 3). Specifically, 400° Fahrenheit (204° Celsius) may be applied for a period of time ranging from twenty seconds to two minutes, at a pressure of 3-30 p.s.i. Of course, other temperatures, times and pressures can be used depending, for example, on the transfer medium 32, the plastic film 34 and/or the image 30. With regard to which plastic film 34 or other material is used, a polycarbonate, polyester, ABS or PBT film can be used. Such plastic films are generally commercially available, such as from, for example, GE plastics or Bayer plastics. Of course, other types of plastic film can be used besides polycarbonate, polyester, ABS or PBT film. Regardless, the application of heat and pressure over a period of time preferably causes at least a portion of the image 30 which was printed onto the transfer medium 32 to be transferred to the film 34. Once the film 34 is removed from the transfer medium 32 (step “D” in FIGS. 2 and 3), preferably at least a portion of the image (also numbered 30 in FIG. 2) is visible on the film 34, and a “ghost image” 40 (i.e. a washed out version of image 30) may remain on the transfer medium 32. The transfer can be applied to either side of the film.

Subsequently, the transfer medium 32 may be discarded and the plastic film 34 (with the image 30 thereon) may be shaped (if it must be) to generally correspond with at least a portion of a surface of the finished plastic part. To shape the film, the film may be loaded into a thermo-former which includes a preforming tool item 42, and heated (using heat item 44) to glass transition (step “E” in FIGS. 2 and 3). The film is engaged with, and vacuum formed to, the pre-forming tool item 42 using a vacuum item 46 (step “F” in FIGS. 2 and 3). As a result of thermo-forming, the film 34 becomes a pre-formed film having the image thereon (identified with reference number 48).

Subsequently, the pre-formed film 48 (with image 30 thereon) is removed from the thermo-former (step “G” in FIGS. 2 and 3), and, if the pre-formed film 48 must be cut, is loaded onto a tooling item 50 of a die set item 52 (step “H” in FIGS. 2 and 3). Then, a force item 54 is used to engage the pre-formed film 48 and remove any excess material. Such excess material may include, for example, edge material as well as cut outs (such as, for example, cut outs for the key pad and display area if the resulting plastic part is to be a plastic cell phone cover). The die-cut, preformed film (identified with reference number 60) is then removed from the die set item 52 (step “I” in FIGS. 2 and 3).

Of course, it is possible that the film 34 need be shaped, but not cut, in which case the film 34 may be thermo-formed (i.e. steps “E”, “F” and “G” in FIGS. 2 and 3), but may not be die-cut (i.e. step “H” in FIGS. 2 and 3). Additionally, it is possible that the film need not be shaped, but must be cut, in which case the film may not be thermo-formed, but may be die-cut. Still further, obviously there are other ways to shape and/or cut the film besides using the thermo-former and die-set item as described above. Regardless, once the film with the image thereon is shaped (if it must be) and/or cut (if it must be) as desired, the film 60 may be loaded into a mold cavity, such as in the cavity side 62, of a plastic injection molding machine (step “J” in FIGS. 2 and 3). Then, the mold cavity is closed, and plastic resin is injected into the mold cavity. As the plastic resin is injected, it bonds with the film 60 which is disposed in the mold cavity. After the plastic resin has been injected (and the plastic allowed to generally harden), the mold cavity is opened, and the resulting plastic piece (identified with reference numeral 80) is ejected (step “K” in FIGS. 2 and 3). Specifically, the plastic piece may be ejected from a core side item 64 of the plastic injection molding machine.

As shown in FIG. 2, the resulting plastic piece 80 may comprise a finished part, such as a full surface decorated plastic part having a “one-of-a-kind” graphic sublimation-printed thereon. As discussed above, sublimation, because the image is actually embedded in the film, is scratch resistant and durable. The method described above, by avoiding silk screen printing, provides that short production runs are economically feasible, and provides that a plastic part can be decorated with a high resolution, “one of a kind” graphic within a high volume production environment. Although not specifically discussed above, transparent sublimation dyes can be used to enable the back-lighting of graphics with the use of “glow in the dark” resins and/or flood-coated dyes. In fact, many design options are possible.

The method illustrated in FIGS. 4 and 5 provides that an antistatic treated film is used in order to enable direct digital color laser printing to the film with standard toners. Initially, a plastic film which can withstand the high heat associated with a color laser printing process is treated with an antistatic coating. Specifically, an antistatic coating is sprayed or otherwise applied to either surface of the film. For example, Static Guard (i.e. Dimethyl Ditallow Ammonium Chloride) may be sprayed onto the film, or one of many other industrial antistatic topical coatings, such as 3000MC Staticide from ACL Staticide, Inc. is be sprayed or otherwise applied to the film. The antistatic coating may be applied using any of many methods for applying coatings, such as: spray, roller coater, silk screen, rotary gravure, litho, off set, draw rod, etc. The film which is coated with the antistatic coating may be High Impact Polystyrene (HIPS), polycarbonate, or another type of film which can withstand the high heat of the color laser printing process.

As an alternative to coating the film with an antistatic coating, a conductive material may be added to the film when the film is extruded. This is common within the electronics industry for insulating films that would not build up static charge that could damage chips. This method can attain 10⁻¹² to 10⁻¹⁵ Ohms resistance which dissipates static charges.

Regardless of which type of film is used, which type of antistatic treatment is used, and how the antistatic coating, if used, is applied, preferably, a plastic film 100 with antistatic treatment 102 is provided (step “A” in FIGS. 4 and 5). Then, an image 104 is printed onto the antistatic treated film 100, preferably using a color laser printer with standard toners (step “B” in FIGS. 4 and 5). For example, a Hewlett-Packard 4550 color laser printer with standard toners can be used to print the image onto the film. The image can be printed onto either surface of the film. Then, depending on the nature of the film, a protective coating item 106 or laminate item 108 may be applied to the film 100 (step “C” in FIGS. 4 and 5).

Subsequently, the film 100 (with the image 104 thereon) may be shaped (if it must be) to generally correspond with at least a portion of a surface of the finished plastic part. To shape the film, the film may be loaded into a thermo-former which includes a pre-forming tool item 110, and heated (using heat item 112) to glass transition (step “D” in FIGS. 4 and 5). The film is engaged with, and vacuum formed to, the pre-forming tool item 114 using a vacuum item 116 (step “E” in FIGS. 4 and 5). As a result of thermo-forming, the film 100 becomes a pre-formed film having the image thereon (identified with reference number 118).

Subsequently, the pre-formed film 118 (with image 104 thereon) is removed from the thermo-former (step “F” in FIGS. 4 and 5), and if required, the ink is cured by exposing the pre-formed film 118 to an ultraviolet lamp 120. Then, if the pre-formed film 118 must be cut, the pre-formed film 118 is loaded onto a tooling item 120 of a die set item 122 (step “G” in FIGS. 4 and 5). Then, a force item 124 is used to engage the pre-formed film 118 and remove any excess material. Such excess material may include, for example, edge material as well as cut outs (such as, for example, cut outs for the key pad and display area if the resulting plastic part is to be a plastic cell phone cover). The die-cut, pre-formed film (identified with reference number 130) is then removed from the die set item 122 (step “H” in FIGS. 4 and 5).

Of course, it is possible that the film 100 need be shaped, but not cut, in which case the film 100 may be thermo-formed (i.e. steps “D”, “E” and “F” in FIGS. 4 and 5), but may not be die-cut (i.e. step “G” in FIGS. 2 and 3). Additionally, it is possible that the film need not be shaped, but must be cut, in which case the film may not be thermo-formed, but may be die-cut. Still further, obviously there are other ways to shape and/or cut the film besides using the thermo-former and die-set item as described above. Regardless, once the film with the image thereon is shaped (if it must be) and/or cut (if it must be) as desired, the film 130 may be loaded into a mold cavity, such as in the cavity side 132, of a plastic injection molding machine (step “I” in FIGS. 4 and 5). Then, the mold cavity is closed, and plastic resin is injected into the mold cavity. As the plastic resin is injected, it bonds with the film 130 which is disposed in the mold cavity. After the plastic resin has been injected (and the plastic allowed to generally harden), the mold cavity is opened, and the resulting plastic piece (identified with reference numeral 140) is ejected (step “J” in FIGS. 4 and 5). Specifically, the plastic piece may be ejected from a core side item 134 of the plastic injection molding machine. As shown in FIG. 4, the resulting plastic piece 140 may comprise a finished part, such as a full surface decorated plastic part having a “one-of-a-kind” graphic thereon.

By utilizing a digital color laser printer with standard toners and antistatic treated films, it is possible to print high resolution “one of a kind” graphics directly onto a plastic film which can thereafter be thermo-formed, die cut and inserted into a mold. The method illustrated in FIGS. 4 and 5 provides a cost savings over the method illustrated in FIGS. 2 and 3 by eliminating the transfer process step. The method also allows the use of lower cost films, toners and ink.

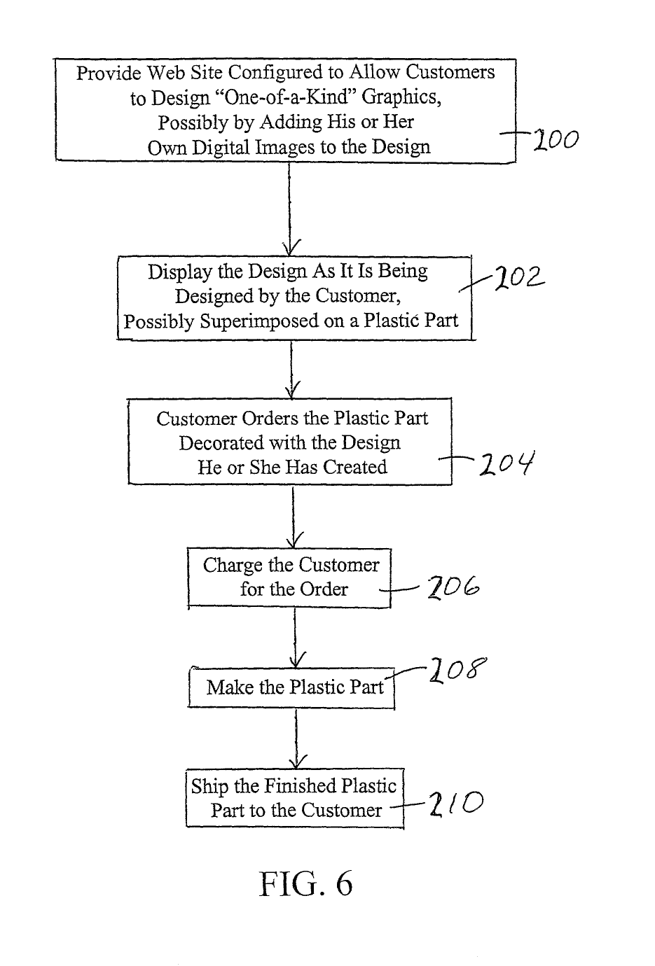

The methods described above also render possible certain business models which were not previously economically feasible. Specifically, the methods make it possible to implement a business model directed at allowing a customer to design a “one-of-a-kind” graphic, and order a plastic part decorated with the “one-of-a-kind” graphic. Specifically, the business model may be as shown in FIG. 6, and may include providing a web site (box 200) which allows a customer to enter the web site, design a “one-of-a-kind” graphic, and order a plastic part (box 204) decorated with the “one-of-a-kind” graphic. For example, the web site may provide that the customer can design (and order) a “one-of-a-kind” plastic cell phone cover. Preferably, the web site is configured to allow the customer to add his or her own digital images to the design, such as digital photographs and personal clip art. Preferably, the web site displays the design as it is being designed by the customer (box 202), and allows the customer to choose a template (or a blank template can be used), upload images, click and drag images onto the part, preview the plastic part with the image(s) thereon, change the background color and add text. The design may be displayed superimposed on a plastic part which may end up being ordered by the customer. After the customer is satisfied with the design he or she has created, preferably the web site allows the customer to order the plastic part with the design (box 204). Subsequently, the customer is charged for the order (box 206), the plastic part is made (box 208) preferably by using the manufacturing process described above, and the finished plastic part is shipped to the customer (box 210).

While embodiments of the present invention are shown and described, it is envisioned that those skilled in the art may devise various modifications without departing from the spirit and scope of the foregoing description.

What is claimed is:

1. A method of decorating a plastic part, said method comprising: printing an image onto a transfer medium; placing the transfer medium against a film; applying pressure and heat to at least one of the transfer medium and film such that at least a portion of the image which has been printed onto the transfer medium transfers onto the film; positioning the film inside a mold cavity of an injection molding machine; closing the mold cavity; injecting a resin into the mold cavity; ejecting the plastic part from the mold cavity, where the plastic part includes plastic and the film with the image thereon bonded to the plastic.

2. A method as recited in claim 1, wherein the step of printing the image onto the transfer medium comprises using sublimation dye.

3. A method as recited in claim 2, further comprising using an ink jet printer utilizing ink jet cartridges that contain sublimation dye to print the image onto the transfer medium.

4. A method as recited in claim 1, further comprising using a color laser printer utilizing sublimation toner dyes to print the image onto the transfer medium.

5. A method as recited in claim 1, wherein the step of applying pressure and heat to at least one of the transfer medium and film, comprises applying 400° Fahrenheit (204° Celsius) for a period of time ranging from twenty seconds to two minutes, at a pressure of 3-30 p.s.i.

6. A method as recited in claim 1, further comprising shaping the film after printing the image onto the film and before positioning the film inside the mold cavity of the injection molding machine.

7. A method as recited in claim 1, further comprising cutting the film after printing the image onto the film and before positioning the film inside the mold cavity of the injection molding machine.

8. A method as recited in claim 1, further comprising cutting and shaping the film after printing the image onto the film and before positioning the film inside the mold cavity of the injection molding machine.

9. A method as recited in claim 1, wherein the plastic film is at least one of a polycarbonate, polyester, ABS or PBT film.

10. A method of decorating a plastic part, said method comprising: providing an antistatic treated film; printing an image onto at least one side of the antistatic treated film; positioning the film inside a mold cavity of an injection molding machine; closing the mold cavity; injecting a resin into the mold cavity; and ejecting the plastic part from the mold cavity, where the plastic part includes plastic and the film with the image thereon bonded to the plastic.

11. A method as recited in claim 10, further comprising using a laser printer to print the image onto the antistatic treated film.

12. A method as recited in claim 10, further comprising providing a plastic film and treating the plastic film with an antistatic coating, thereby providing said antistatic treated film.

13. A method as recited in claim 12, further comprising applying Dimethyl Ditallow Ammonium Chloride to the plastic film.

14. A method as recited in claim 12, wherein the step of treating the plastic film with an antistatic coating comprising applying the antistatic coating using at least one of the following methods: spray, roller coater, silk screen, rotary gravure, litho, off set, draw rod.

15. A method as recited in claim 10, further comprising providing a plastic film and adding a conducive material to the plastic film, thereby providing said antistatic treated film.

16. A method as recited in claim 10, further comprising applying a protective coating or laminate to the film.

17. A method as recited in claim 10, wherein the film is High Impact Polystyrene (HIPS), polycarbonate, or another type of film which can withstand the high heat of a color laser printing process.

18. A business model directed at allowing a customer to design a graphic, and order a plastic part decorated with the graphic, said business model comprises providing a web site which allows the customer to design the graphic, and order the plastic part decorated with the graphic, said web site being configured to allow the customer to add one or more digital images to the design, wherein said web site displays the design as it is being designed by the customer, wherein the design is displayed superimposed on an image of the plastic part which may end up being ordered by the customer.

19. A business model as recited in claim 18, wherein the web site is configured to allow the customer to choose a template, upload one or more images, click and drag one or more images onto the image of the plastic part, and preview the plastic part with the one or more images thereon.

20. A business model as recited in claim 19, wherein the web site is configured to allow the customer to change the background color and add text to the design.

21. A business model as recited in claim 19, wherein the web site is configured to allow the customer to order the plastic part with the design, whereafter the customer is charged for the order, the plastic part is made, and the finished plastic part is shipped to the customer.
